(19) United States
(12) Patent Application Publication
(10) Pub. No.: US 2026/0348517 A1
(43) Pub. Date: Nov. 5, 2026

(54) SUCTION MOUNTING ASSEMBLY

(71) Applicant: Decolin Inc., Montreal (CA)

(72) Inventors: Benjamin Scanlon, Philadelphia, PA (US); Frank Coratolo, Blackwood, NJ (US); Thomas Powers, Wilmington, DE (US)

(21) Appl. No.: 19/667,387

(22) Filed: May 4, 2026

Related U.S. Application Data
(60) Provisional application No. 63/800,163, filed on May 5, 2025.

(51) Int. Cl. F16M 13/02; F16B 47/00

(52) U.S. Cl. CPC F16M 13/022; F16B 47/006; F16B 2200/00

(57) ABSTRACT

A suction mounting assembly has a suction pad with flexible internal structure extending toward the radially outer periphery of the suction pad. The flexible internal structure helps prevent peripheral edges of the suction pad from puckering as the suction mounting assembly is actuated, particularly when softer material is used for the suction pad to facilitate adherence to a textured surface. This helps prevent loss of vacuum seal that could cause the suction mounting assembly to fall from the surface to which it is mounted. A threaded post may extend from the center of the suction pad assembly and through the mounting assembly’s housing. A lever adapter piece at a distal end of the threaded post permits a lever-type cam mechanism to be used to actuate the suction mounting assembly instead of a rotatable handle.

### CROSS-REFERENCE TO RELATED APPLICATIONS

The present application claims the priority benefit of U.S. provisional patent application 63/800,163 filed May 5, 2025, the contents of which are incorporated herein by reference.

### FIELD OF THE INVENTION

The claimed invention relates to suction mounting assemblies of the type often used in shower or bath stalls.

### BACKGROUND

Many bath accessories such as hooks, baskets, shower caddies, soap dishes, etc. are secured to a vertical wall surface (i.e., a mounting surface) using suction mounting assemblies. Conventional assemblies may not provide optimal securement. For example, when the mounting surface to which such a suction mounting assembly is textured, gaps can form between the periphery of the wall-facing contact surface of the suction pad and the mounting surface. These gaps break the partial vacuum, thereby allowing the suction mounting assembly to fall from the mounting surface.

### SUMMARY OF THE CLAIMED INVENTION

Embodiments of suction mounting assemblies in accordance with the claimed invention may have suction pads that are softer than those used elsewhere, to facilitate adherence of the suction mounting assemblies to mounting surfaces with slight amounts of texture. To prevent the softer suction pads from wrinkling or puckering more easily near their edges as the central region is drawn away from the mounting surface to create the partial vacuum, which wrinkling or puckering would break the vacuum seal, the embodiments include flexible support structure on or within their suction pads. The flexible support structure extends toward, and possibly entirely or almost entirely to, the radially outer periphery of the suction pad. The flexible support structure may be overmolded by material from which the suction pad is made or co-molded with the suction pad.

Furthermore, in the disclosed embodiments of suction mounting assemblies in accordance with the claimed invention, a threaded post may extend perpendicularly from the center of the flexible suction pad and through the mounting assembly’s housing. A lever adapter piece may be connected to a distal end of the threaded post. The lever adapter piece may be configured to permit a lever-type cam mechanism to be used to draw the threaded post – and hence the suction pad – away from the mounting surface. Use of such a lever adapter piece makes it possible to use one configuration of the suction pad assembly with either a rotatable handle or a lever-type cam mechanism to actuate the suction mounting assembly and adhere it to a mounting surface. This facilitates manufacturing of different product configurations using the same component and thereby may reduce manufacturing costs.

Thus, in a first aspect, the claimed invention features a suction mounting assembly that includes a housing with a cavity defined and partially bounded by a top wall of the housing and a sidewall of the housing. The top wall of the housing has a central opening. A suction pad member is supported by the housing and includes a suction pad support portion; a support stem extending perpendicularly from the center of the suction pad support portion and through the central opening of the housing top wall; and a flexible suction pad extending across the cavity of the housing with a substantially flat lower contact surface. The suction pad support portion includes flexible structure that is at least partially embedded within the suction pad and that extends radially outward from a central portion of the suction pad support portion toward radially peripheral edges of the suction pad. The suction mounting assembly further includes an actuator that is located external to the cavity. The actuator is structured and arranged to draw the suction pad support portion of the suction pad member, and hence the suction pad, in toward the cavity of the housing via the support stem when the actuator is manipulated.

In another aspect, the claimed invention features a suction mounting assembly that includes a cavity defined and partially bounded by a top wall of the housing and a sidewall of the housing. The top wall of the housing has a central opening. A suction pad member is supported by the housing and includes a suction pad support portion; a support stem extending perpendicularly from the center of the suction pad support portion and through the central opening of the housing top wall; and a flexible suction pad extending across the cavity of the housing and having a substantially flat lower contact surface. The mounting assembly further includes an actuator located external to the cavity, with the actuator being structured and arranged to draw the suction pad support portion of the suction pad member, and hence the suction pad, in toward the cavity of the housing via the support stem when the actuator is manipulated. The support stem is externally threaded and further includes a lever adapter piece that is threadedly attached to a distal end of the support stem and that extends partially through the central opening of the housing, with the actuator being connected to the support stem via the lever adapter piece.

### BRIEF DESCRIPTION OF THE DRAWINGS

FIG. 1 is perspective view of a suction mounting assembly in accordance with the claimed invention, and FIG. 2 is an exploded view thereof;

FIG. 3 is a section view of a housing used in the suction mounting assembly shown in FIGS. 1 and 2;

FIGS. 4, 5, and 6, are a perspective view, a side view, and a section view, respectively, of a suction pad member used in the suction mounting assembly shown in FIGS. 1 and 2;

FIGS. 7, 8, and 9, are a perspective view, a side view, and a section view, respectively, of a pad-supporting frame used in the suction pad member shown in FIGS. 7-9;

FIGS. 10 and 11 are a perspective view and a section view, respectively, of a lever adapter piece used in the suction mounting assembly shown in FIGS. 1 and 2;

FIGS. 12 and 13 are section views of the suction mounting assembly in a non-actuated state and an actuated state, respectively; and

FIGS. 14 and 15 are a perspective view and a section view, respectively, of a lever handle used in the suction mounting assembly shown in FIGS. 1 and 2.

### DETAILED DESCRIPTION

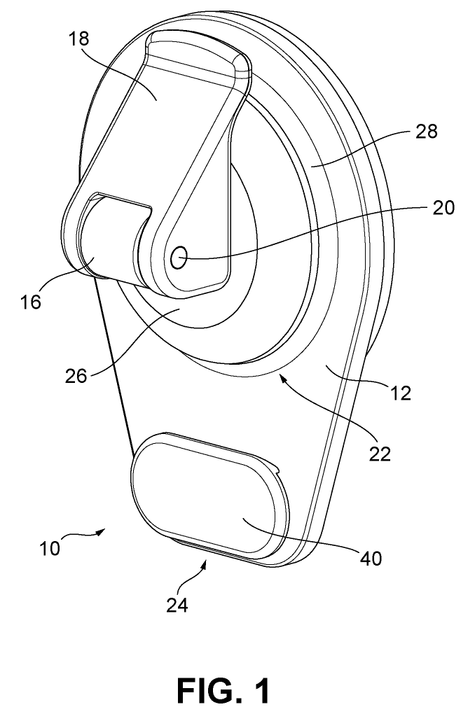

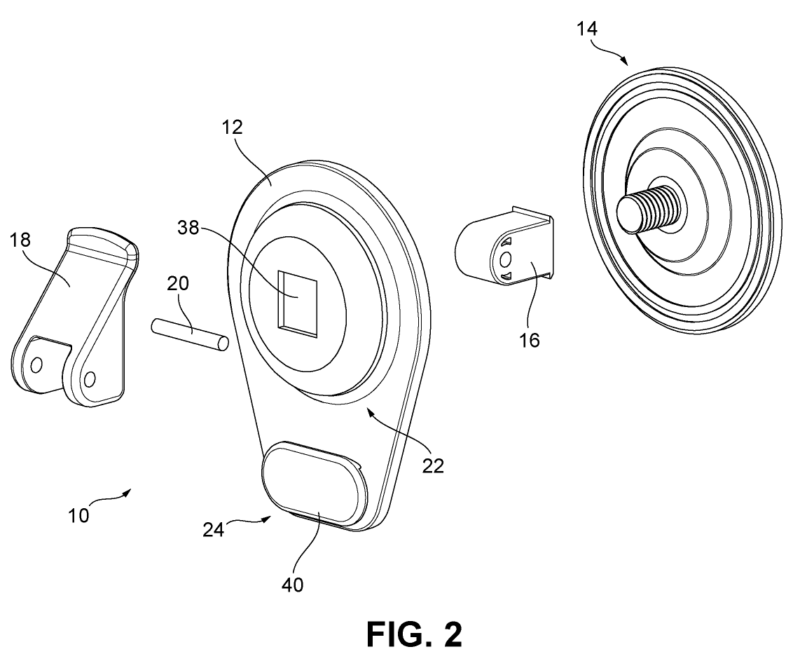

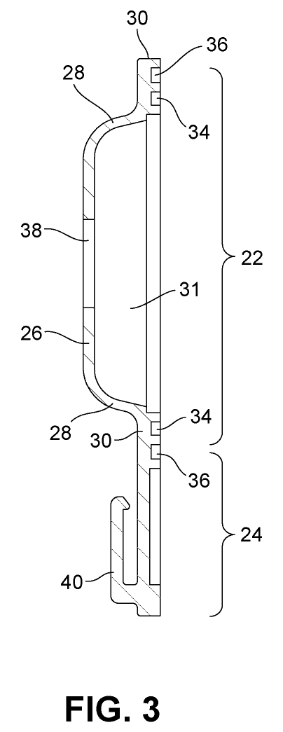

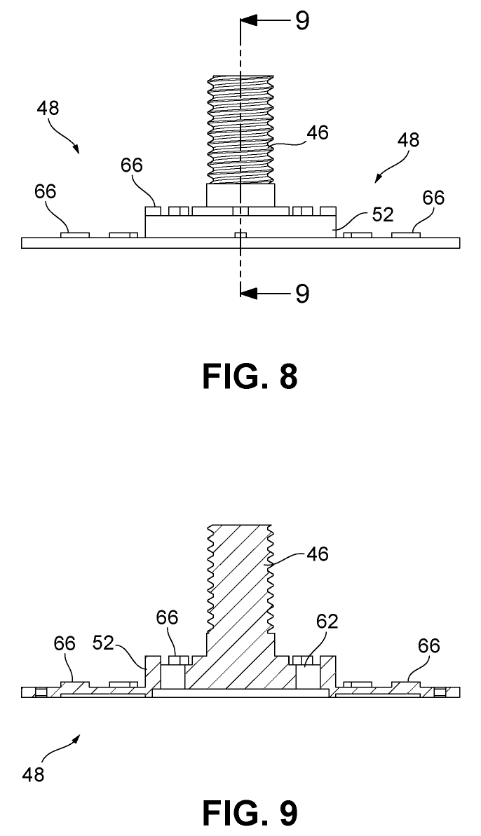

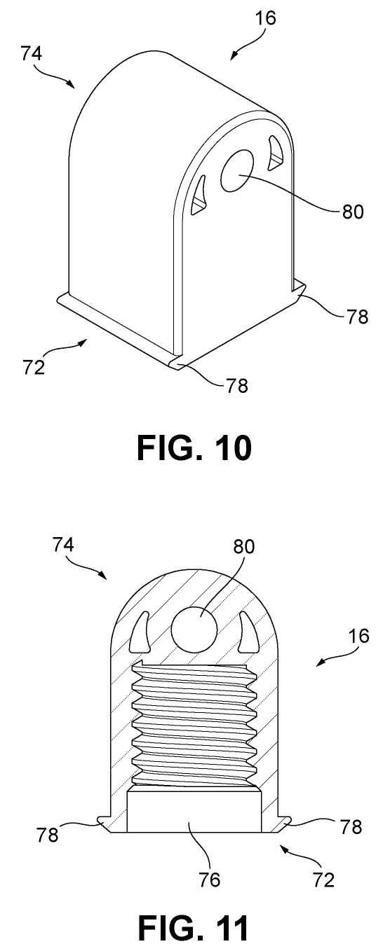

An embodiment of a suction mounting assembly 10 in accordance with the claimed invention is illustrated in FIGS. 1-15. In general, as illustrated in FIGS. 1 and 2, the suction mounting assembly 10 includes a housing 12, a suction pad member 14, a lever adapter piece 16, and a lever handle 18 that is pivotally attached to the lever adapter piece 16 by means of a pivot pin 20.

As illustrated in FIGS. 1-3, 12, and 13, the housing 12 includes a main, suction pad-supporting portion 22 and an accessory-supporting portion 24. The suction pad-supporting portion 22 of the housing 12 includes a circular top wall 26, a sidewall 28 that surrounds and slants away from the top wall 26, and a base flange 30 that extends radially outwardly from the sidewall 28 at a portion of the sidewall 28 that is opposite to the top wall 26. Together the top wall 26 and the side wall 28 define and partially bound a cavity 31 into which the suction pad member 14 is partially drawn during actuation of the suction mounting assembly 10. The base flange 30 lies in a plane that is spaced from and generally parallel to the top wall 26. Suitably, the bottom surface of the base flange 30 – i.e., the surface of the base flange 30 that faces away from the top wall 26 of the housing 12 and toward a mounting surface when the suction mounting assembly 10 is installed for use – includes at least two concentric circular grooves 34, 36 located radially outside of the sidewall 28. The concentric circular grooves 34, 36 receive corresponding raised concentric rings of the suction pad to prevent the suction pad from puckering in use, as described more fully below.

A central opening 38 is provided in the top wall 26 of the housing 12, and the lever adapter piece 16, which is attached to the suction pad member 14, extends through the central opening 38 from the underside of the housing 12 (i.e., the side of the housing 12 on which the suction pad is located) to the top, exterior side of the housing 12. Suitably, the central opening 38 is non-circular to prevent relative rotation between the suction pad member 14 and the housing 12.

The housing 12 may be made of any suitable, water-resistant material such as plastic, metal, and the like. For example, suitable plastics include polypropylene (PP), acrylonitrile butadiene styrene (ABS), high impact polystyrene (HIPS), nylon, and the like. As illustrated in the figures, the accessory-supporting portion 24 of the housing 12 may be formed as an extension of the base flange 30 and may include accessory-supporting features 40 such as hooks, etc., integrally formed therewith.

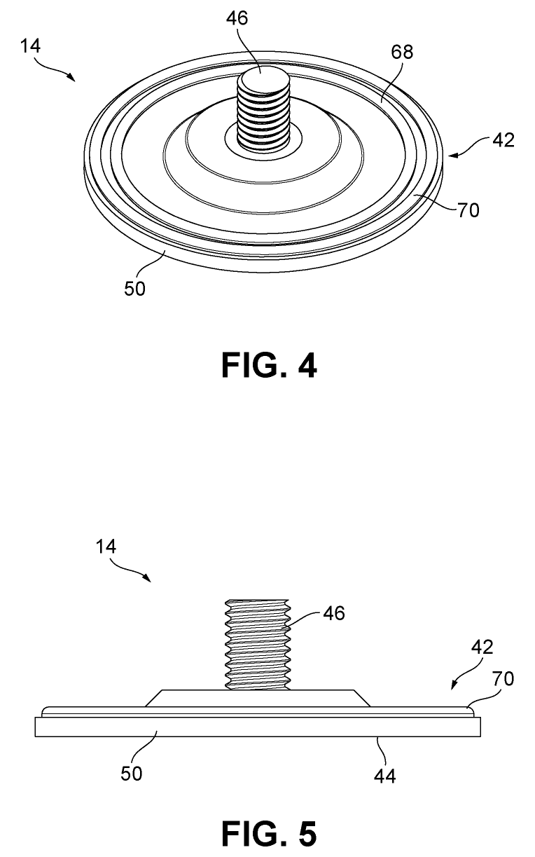

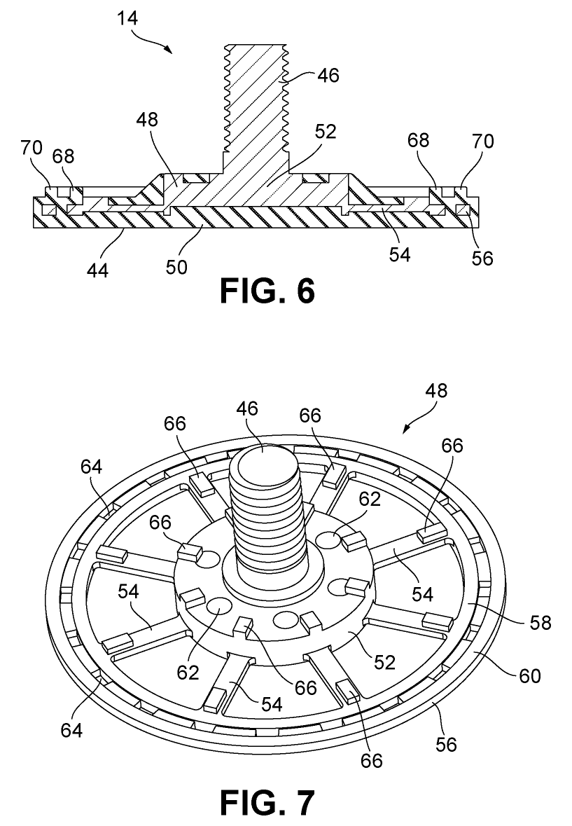

As illustrated in FIGS. 4-9, the suction pad member 14 includes a disc-shaped suction pad support portion 42 with a substantially flat lower contact surface 44 and a threaded support stem 46 that extends perpendicularly to the suction pad support portion 42 from the center of the suction pad support portion 42. As illustrated in FIG. 6, the suction pad member 14 includes a pad-supporting frame 48 that is overmolded or co-molded with the material used to form the suction pad 50, per se, such that the pad-supporting frame 48 is at least partially embedded within the suction pad 50. The pad-supporting frame 48 may be made from any suitable material including plastics, metals and the like. For example, suitable plastics include PP, ABS, HIPS, nylon, polycarbonate, and the like.

In general, the material used to form the suction pad 50 may be softer than materials most often used to form the suction pads of suction mounting assemblies as known in the prior art. Exemplary materials used in the disclosed embodiment may include TPR (thermoplastic rubber), TPE (thermoplastic elastomer), TPU (thermoplastic polyurethane), and similarly soft, flexible, surface-conformable materials. Suitably, the material used to form the suction pad 50 has a shore hardness ranging from about 20A (lower end of the shore hardness range for TPU) to about 95A (upper end of the shore hardness range for TPE), which may allow the disclosed suction mounting assembly 10 to adhere to somewhat textured surfaces.

Furthermore, the pad-supporting frame 48 includes a central, disc-shaped hub 52; multiple flexible fingers 54 (e.g., eight as illustrated) extending radially outward from the hub 52 in spoke-like fashion; and a radially outer support ring 56 integrally molded with and attached to the radially outer ends of the flexible fingers 54. As illustrated, the hub 52 is substantially thicker and more monolithic than the flexible fingers 54, which makes the hub 52 significantly more rigid than the flexible fingers 54. As a result, the hub 52 remains essentially undeformed when the suction mounting assembly is actuated by drawing the center of the suction pad support portion 42 away from the mounting surface.

Suitably, the threaded support stem 46 is integrally molded with the hub 52 as illustrated. Alternatively, the hub 52 may include an internally threaded central bore (not illustrated), and the threaded support stem may be screwed into such an internally threaded central bore.

As shown in FIGS. 6-9, a pair of concentric rings 58, 60 protrude upwardly from the upper surface of the support ring 56 and extend circumferentially along the support ring 56. Furthermore, multiple holes 62 that are angularly spaced around the hub 52 extend through the hub 52, from the upper surface of the hub 52 to the lower surface of the hub 52. Additionally, multiple slots 64 that are circumferentially spaced along the support ring 56 extend through the support ring 56, from the upper surface of the support ring 56 to the lower surface of the support ring 56. Further still, multiple bump-like protrusions 66 are formed on the upper surface of the hub 52 and/or the upper surfaces of the flexible fingers 54. When the suction pad 50 is formed (either by over-molding or co-molding, as noted above), the suction pad material flows into the various holes 62 and slots 64 and around the bump-like protrusions 66, which helps to anchor the position of the suction pad 50 on the frame 48.

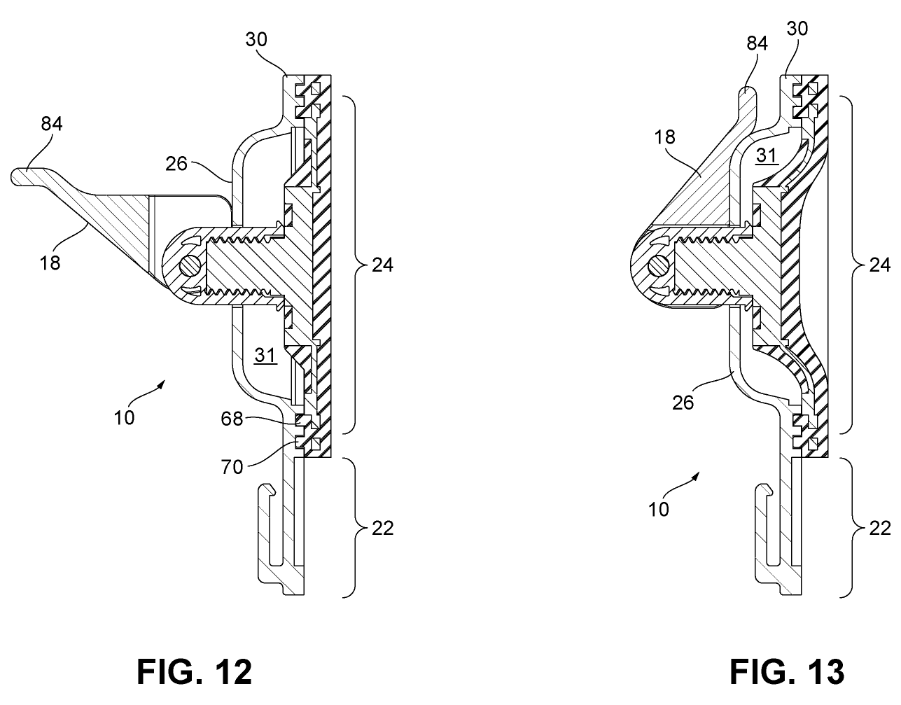

As mentioned above, the suction pad 50 is formed with a pair of raised concentric rings 68, 70 that protrude from the upper surface of the suction pad 50. The raised concentric rings 68, 70 of the suction pad 50 overlie the raised concentric rings 58, 60 formed on the support ring 56 of the pad-supporting frame 48. Furthermore, the diameters and profiles of the raised concentric rings 68, 70 of the suction pad 50 are sized to fit within the concentric circular grooves 34, 36 formed on the bottom surface of the housing base flange 30 when the suction mounting assembly 10 is assembled, as shown in FIGS. 12 and 13. This engagement of the concentric rings 68, 70 of the suction pad 50 within the concentric grooves 34, 36 on the bottom surface of the housing base flange 30 further helps to prevent the suction disc 50 from puckering when the suction mounting assembly is actuated, thereby helping to maintain the partial vacuum that secures the suction mounting assembly 10 to the mounting surface.

As illustrated in FIGS. 2, 10, and 11, , the lever adapter piece 16 may be a generally block-shaped element with a squared or rectangular profile as seen from above (not illustrated), a flattish lower end 72 as seen in profile, and a rounded upper end 74 as seen in profile. The profile of the lever adapter piece 16 as seen from above matches the shape of the central opening 38 in the top wall 26 of the housing 12, although it is slightly smaller to permit the lever adapter piece 16 to fit easily within the central opening 38 in the top wall 26 of the housing 12. The lever adapter piece 16 may have an internally threaded bore 76 extending into it from the lower end 72 of the lever adapter piece 16 and one or more flanges 78 protruding slightly outwardly from the lower ends of the lever adapter piece’s sidewalls. A pin-receiving bore 80 extends through the upper end 74 of the lever adapter piece 16, from one side of the lever adapter piece 16 to the opposite side of the lever adapter piece 16.

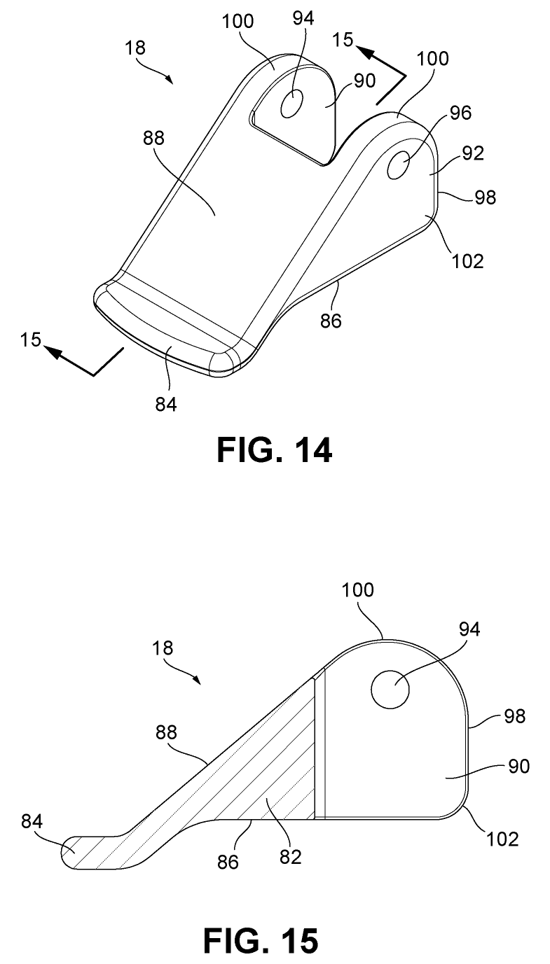

The lever handle 18 is illustrated in FIGS. 14 and 15. The lever handle 18 may be made of any suitable material including plastics, metals, and the like. For example, suitable plastics include PP, ABS, HIPS, nylon, and the like. The lever handle 18 includes a generally triangular central body portion 82 with an actuation flange 84 that extends slightly downwardly and away from the central body portion 82. The lower surface 86 of the central body portion 82 is flat, and an upper surface 88 of the central body portion 82 slopes upwardly at an angle away from the actuation flange 84.

A spaced-apart pair of ears 90, 92 extend rearwardly from the central body portion 82 of the lever handle 18, with one on either side of the lever handle 18, and an aligned pair of pin-receiving holes 94, 96 extend through the ears 90, 92. The ears 90, 92 are spaced far enough apart from each other to accommodate the body of the lever adapter piece 16 between them. Back surfaces 98 of the ears 90, 92 may be substantially perpendicular to the lower surface 86 of the central body portion 82. Upper corners 100 of the ears 90, 92 are rounded, with curvature that matches the curvature of the upper end 74 of the lever adapter piece 16 for smooth aesthetics, and the lower corners 102 of the ears 90, 92 are rounded but with a smaller radius of curvature than the upper corners 100 of the ears 90, 92. The lower corners 100 of the ears 90, 92 function as camming surfaces when the suction mounting assembly 10 is actuated.

As illustrated in FIGS. 12 and 13, the suction mounting assembly 10 is assembled by screwing the lever adapter piece 16 onto the distal end of the threaded support stem 46, then inserting the rounded upper end 74 of the lever adapter piece 16 through the central opening 38 in the top wall 26 of the housing 12 from the lower, suction pad-receiving side of the housing 12 toward the upper, exterior-facing side of the housing 12. The flanges 78 protruding outwardly from the lower ends of the lever adapter piece’s sidewalls prevent the lever adapter piece 16 from passing completely through the central opening 38 in the top wall 26 of the housing 12. The lever handle 18 is then positioned with the ears 90, 92 on either side of the lever adapter piece 16 with the pin-receiving holes 94, 96 in the ears 90, 92 aligned with the pin-receiving bore 80 extending through the upper end 74 of the lever adapter piece 16; with the back surfaces 98 of the ears 90, 92 flush with or adjacent to the upper surface of the top wall 26 of the housing 12; and with the actuation flange 84 extending upwardly as shown in FIG. 12. The pivot pin 20 is then inserted through the pin-receiving holes 94, 96 in the ears 90, 92 and the pin-receiving bore 80 extending through the upper end 74 of the lever adapter piece 16 to secure the lever handle 18 to the lever adapter piece 16 in a manner that allows the lever handle 18 to pivot relative to the lever adapter piece 16 and the threaded support stem 46.

Suitably, the various components and features of the suction mounting assembly 10 are dimensioned and positioned so that the lower contact surface of the suction pad 50 remains essentially flat when the lever handle 18 is in the position shown in FIG. 12, with the back surfaces 98 of the ears 90, 92 flush with or adjacent to the upper surface of the top wall 26 of the housing 12 and with the concentric rings 68, 70 protruding from the upper surface of the suction pad 50 received within the concentric grooves 34, 36 on the bottom surface of the housing base flange 30. The suction mounting assembly 10 may then be attached to the mounting surface and actuated easily by positioning the bottom surface of the suction pad 50 against the mounting surface and pivoting the lever handle 18 downwardly about the pivot pin 20 into the position shown in FIG. 13. As the lever handle 18 is pivoted downwardly, the lower corners 102 of the ears 90, 92 bear against the upper surface of the top wall 26 of the housing 12 and the lever handle 18 pivots about and slides along those corners 102. The pivot pin 20 is pushed up simultaneously, thereby pulling the threaded stem 46 up and partially out of the housing 12.

As the threaded stem 46 is pushed upwardly, it pulls the substantially rigid hub 52 of the pad-supporting frame 48 – and hence the central portion of the suction pad 50 – away from the mounting surface and toward the cavity 31 of the housing 12, thereby creating a partial vacuum between the suction pad 50 and the mounting surface that holds the suction mounting assembly 10 to the mounting surface. As noted above, however, the fingers 54 extending from the hub are flexible, which enables them – along with the overlying/overmolded suction pad 50 – to slope downwardly from the raised position of the hub 52 to the mounting surface-adjacent position beneath the base flange 30. This helps prevent the periphery of the suction pad 50 from being drawn radially inwardly and puckering when the suction mounting assembly 10 is actuated. So, too, does the support ring 56; engagement of the protruding concentric rings 68, 70 on the upper surface of the suction pad 50 within the grooves 34, 36 on the bottom surface of the base flange 30; and pressure applied by the raised concentric rings 68, 70 on the support ring 56 to help hold the concentric rings 68, 70 of the suction pad 50 within the base flange grooves 34, 36 as suction and the threaded stem 46 “pull” the housing 12 toward the mounting surface. As long as the periphery of the contact surface of the suction pad 50 remains sealed against the mounting surface, a partial vacuum is maintained inside the recessed suction cup, which securely holds the suction mounting assembly 10 to the mounting surface.

In the embodiment of a suction mounting assembly described above, the cam-action lever handle 18 is used as an actuator that is structured and arranged to draw the central portion of the suction pad 50 up toward the cavity 31 of the housing 12, thereby creating the partial vacuum that holds the suction mounting assembly to a mounting surface. It is also possible to use a rotary knob mechanism such as that disclosed in U.S. Patent No. 11,415,166 (incorporated by reference) – or similar – as the actuator to draw the central portion of the suction pad 50 up toward the cavity 31 to create the partial vacuum.

In the embodiment of a suction mounting assembly described above, a suction pad holds the mounting assembly to the mounting surface. However, in another embodiment (not illustrated), the user may be provided with a choice between using a suction pad or an adhesive pad utilizing a single suction cup casing. Users may selectively use the flexible suction pad, or remove the suction pad and replace it with an adhesive pad that can be adhered to various surfaces. The mounting assemblies may thus be secured to a bathroom wall or other smooth flat surfaces by means of a suction pad or by means of an adhesive pad.

In such an interchangeable adhesive pad configuration, the mounting assembly includes the same housing and lever handle as the suction mounting assembly described above. The adhesive pad of the mounting assembly would include an adhesive contact sheet having an exterior contact surface, peripheral edge, and interior face. The adhesive contact sheet would be generally square with rounded corners that extend beyond the radial outer edge of the base flange. This enables a user to grasp the corners when removing the mounting assembly from a wall, and it provides a larger adhesive surface area than the base flange. Alternatively, any other shape such as round may be used for the contact sheet. The adhesive contact sheet may have a typical thickness of from 0.1 to 7 mm, for example, from 0.5 to 3 mm.

The adhesive contact sheet may be made of any suitable materials including plastics such as polyethylene (PE), PP, polyethylene terephthalate (PET), and the like. A layer of adhesive material may be applied on the contact surface of the adhesive contact sheet. The adhesive material may be applied over the entire contact surface, or a portion thereof. Suitable adhesive materials include conventional pressure-sensitive adhesives and the like. A conventional release film may be applied over the adhesive contact surface of the contact sheet prior to installation of the mounting assembly by a user.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention.

We claim:

1. A suction mounting assembly, comprising:
a housing having a cavity defined and partially bounded by a top wall of the housing and a sidewall of the housing, the top wall of the housing having a central opening;
a suction pad member supported by the housing and comprising a suction pad support portion, a support stem extending perpendicularly from the center of the suction pad support portion and through the central opening of the housing top wall, and a flexible suction pad extending across the cavity of the housing and having a substantially flat lower contact surface, the suction pad support portion comprising flexible structure at least partially embedded within the suction pad and extending radially outward from a central portion of the suction pad support portion toward radially peripheral edges of the suction pad; and
an actuator located external to the cavity, the actuator being structured and arranged to draw the suction pad support portion of the suction pad member, and hence the suction pad, in toward the cavity of the housing via the support stem when the actuator is manipulated.

2. The suction mounting assembly of claim 1, wherein the cavity of the housing is circular and the suction pad is disc-shaped.

3. The suction mounting assembly of claim 1, wherein the suction pad support portion comprises a hub in the central portion of the suction pad support portion and the flexible structure comprises flexible fingers extending radially outward from the hub, the hub being thicker than the flexible fingers in the direction in which the support stem extends.

4. The suction mounting assembly of claim 3, wherein the hub has passageways extending through it and wherein the material from which the suction pad is formed is present within the passageways.

5. The suction mounting assembly of claim 3, wherein the hub has a plurality of bump-shaped protrusions formed thereon and wherein the material from which the suction pad is formed surrounds the bump-shaped protrusions.

6. The suction mounting assembly of claim 1, wherein the suction pad support portion further comprises a support ring located radially outside the flexible fingers and joined to ends thereof, the support ring being at least partially embedded within the suction pad.

7. The suction mounting assembly of claim 6, wherein the support ring has passageways extending through it and wherein the material from which the suction pad is formed is present within the passageways.

8. The suction mounting assembly of claim 3, wherein the flexible fingers have a plurality of bump-shaped protrusions formed thereon and wherein the material from which the suction pad is formed surrounds the bump-shaped protrusions.

9. The suction mounting assembly of claim 6, wherein the housing further comprises a base flange located at a lower, mounting surface-facing portion of the housing, the base flange surrounding the cavity and extending radially outward from the housing.

10. The suction mounting assembly of claim 9,
wherein the base flange has a plurality of concentric grooves formed in a lower, mounting surface-facing surface thereof; and
wherein the suction pad has a plurality of concentric rings protruding from an upper surface thereof near the outer periphery therof, with each of the concentric rings being dimensioned and arranged to fit within one of the concentric grooves in the lower, mounting surface-facing surface of the base flange when the suction mounting assembly is actuated and the suction pad is drawn in toward the cavity of the housing.

11. The suction mounting assembly of claim 10, wherein the support ring has a plurality of concentric rings protruding from an upper surface thereof, with the concentric rings protruding from the upper surface of the support ring being aligned with the concentric rings protruding from the upper surface of the suction pad so as to press the concentric rings protruding from the upper surface of the suction pad into engagement with the concentric grooves in the lower, mounting surface-facing surface of the base flange when the suction mounting assembly is actuated and the suction pad is drawn in toward the cavity of the housing.

12. The suction mounting assembly of claim 1, wherein the actuator comprises a cam-action lever pivotally connected to the support stem and disposed exterior to the housing.

13. The suction mounting assembly of claim 12, wherein the support stem is externally threaded and further comprises a lever adapter piece that is threadedly attached to a distal end of the support stem, the lever adapter piece being partially located exterior to the housing and the cam-action lever being pivotally connected to the support stem via the lever adapter piece.

14. The suction mounting assembly of claim 12,
wherein the cam-action lever comprises a body portion and an actuation flange extending therefrom;
wherein the cam-action lever is structured and arranged such that the suction mounting assembly is in a non-actuated configuration, with the suction pad not drawn in toward the cavity of the housing, when the cam-action lever is pivoted such that the actuation flange extends upwardly and away from the housing; and
wherein the cam-action lever is structured and arranged such that the suction mounting assembly is in an actuated configuration, with the suction pad drawn in toward the cavity of the housing, when the cam-action lever has been manipulated such that the actuation flange has been pivoted toward the housing.

15. The suction mounting assembly of claim 1, wherein the suction pad has a shore hardness from about 20A to about 95A.

16. A suction mounting assembly, comprising:
a housing having a cavity defined and partially bounded by a top wall of the housing and a sidewall of the housing, the top wall of the housing having a central opening;
a suction pad member supported by the housing and comprising a suction pad support portion, a support stem extending perpendicularly from the center of the suction pad support portion and through the central opening of the housing top wall, and a flexible suction pad extending across the cavity of the housing and having a substantially flat lower contact surface, and
an actuator located external to the cavity, the actuator being structured and arranged to draw the suction pad support portion of the suction pad member, and hence the suction pad, in toward the cavity of the housing via the support stem when the actuator is manipulated;
wherein the support stem is externally threaded and further comprises a lever adapter piece that is threadedly attached to a distal end of the support stem and that extends partially through the central opening of the housing, the actuator being connected to the support stem via the lever adapter piece.

17. The suction mounting assembly of claim 16 wherein the cavity of the housing is circular and the suction pad is disc-shaped.

18. The suction mounting assembly of claim 16, wherein the actuator comprises a cam-action lever pivotally connected to the lever adapter piece.

19. The suction mounting assembly of claim 18,
wherein the cam-action lever comprises a body portion and an actuation flange extending therefrom;
wherein the cam-action lever is structured and arranged such that the suction mounting assembly is in a non-actuated configuration, with the suction pad not drawn in toward the cavity of the housing, when the cam-action lever is pivoted such that the actuation flange extends upwardly and away from the housing; and
wherein the cam-action lever is structured and arranged such that the suction mounting assembly is in an actuated configuration, with the suction pad drawn in toward the cavity of the housing, when the cam-action lever has been manipulated such that the actuation flange has been pivoted toward the housing.
